(19) United States
(12) Patent Application Publication
(10) Pub. No.: US 2020/0114298 A1
(43) Pub. Date: Apr. 16, 2020

(54) RECEIVER INTEGRATED WITH SEPARATOR

(71) Applicant: Gast Manufacturing, Inc., Benton Harbor, MI (US)

(72) Inventors: Troy Smits, Benton Harbor, MI (US); Drew Covert, Benton Harbor, MI (US); Jeff Lace, Benton Harbor, MI (US)

(73) Assignee: Gast Manufacturing, Inc., Benton Harbor, MI (US)

(21) Appl. No.: 16/600,637

(22) Filed: Oct. 14, 2019

Related U.S. Application Data
(60) Provisional application No. 62/744,910, filed on Oct. 12, 2018.

(51) Int. Cl. B01D 53/04; B01D 53/26; F17C 1/00

(52) U.S. Cl. CPC B01D 53/0423; B01D 53/0446; B01D 53/261; F17C 1/00; B01D 2256/10; F17C 2265/015; B01D 2257/80; B01D 2259/4146; F17C 2205/0323; F17C 2221/014; B01D 2257/104

(57) ABSTRACT

One or more techniques and/or systems are disclosed for an integrated, dual-chamber, gas separator-receiver. The integrated, dual-chamber, gas separator-receiver can comprise a first and second column, which is integrated, and plumbed together. A source gas can be input through an inlet in the first column, and a target gas, separated from the source gas, can be output through an outlet in the second column. The first column can contain agents that dry the source gas, and separate the target gas from the source gas. The source gas can then be fed into the second column, where it is stored under pressure, at least until needed by some target operation that utilizes the target gas.

This nonprovisional patent application claims priority to provisional patent application Ser. No. 62/744,910 filed on Oct. 12, 2018, the entirety of which is incorporated herein by reference.

### BACKGROUND

Nitrogen generators, and other air-gas separator systems, typically use an adsorption gas separation process that can fix various gas mixture components to a solid substance, often referred to as an adsorbent. This separation process, using the gas and adsorbent molecule interaction, often occurs in a separator component, which can be filled with the adsorbent molecule. In the separator chamber, air (or some other gas) in introduced at one end, and drawn through the chamber, with the resulting purified gas exiting at the other end to some type of gas collection component. Some systems use a pressure-swing adsorption technology to help improve purification and re-charging. In these systems, the regulation of gas adsorption and adsorbent regeneration is done by changing pressures in the adsorbent-containing vessel.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems are described herein for an integrated, dual-chamber, gas separator-receiver. For example, a first and second column can be integrated, and plumbed together so that a source gas is input through an inlet in the first column, and a target gas is output through an outlet in the second column. The first column can contain agents that dry the source gas, and/or separate the target gas from the source gas. The source gas can be fed to the second column, where it is stored under pressure, at least until needed by some target operation that utilizes the target gas, such as a nitrogen generator.

In one implementation of system for generating a target gas from a source gas can comprise an integrated, dual column separator-receiver component. The integrated, dual column separator-receiver component can comprise a first column. The first column can comprise a source gas inlet that is disposed at a first end, and a target gas outlet spaced from the source gas inlet. The first column can comprise a desiccant material layer that separates water vapor from the source gas, resulting in a dry source gas. Further, the first column can comprise an adsorbent material layer that separates the target gas from other components of the dry source gas, resulting in a purified form of the target gas.

The integrated, dual column separator-receiver component can comprise a second column. The second column can be integrated with the first column, and be in fluid communication with the target gas outlet, and comprise a storage chamber for receiving and storing the target gas in a pressurized disposition. The second column can comprise a pressurized target gas outlet to provide the source gas for use in a target operation. Further, system for generating a target gas from a source gas can comprise a source gas compressor fluidly coupled with the source gas inlet to collect and compress the source gas, and provide the compressed source gas to the source gas inlet.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a component diagram illustrating an example implementation of one or more portions of an integrated separator and receiver system.

FIG. 2A is a perspective view of an example implementation of a component of an integrated separator and receiver system.

FIG. 2B is a front elevational view of an example implementation of a component of an integrated separator and receiver system shown in FIG. 2A.

FIG. 2C is a left side view of an example implementation of a component of an integrated separator and receiver system shown in FIG. 2B.

FIG. 2D is a right side view of an example implementation of a component of an integrated separator and receiver system shown in FIG. 2B.

FIG. 2E is a top view of an example implementation of a component of an integrated separator and receiver system shown in FIG. 2B.

FIG. 2F is a cross-sectional view of an example implementation of a component of an integrated separator and receiver system taken along line A-A of FIG. 2E.

FIG. 3A is a perspective view of an example implementation of a component of an integrated separator and receiver system.

FIG. 3B a left side view of an example implementation of a component of an integrated separator and receiver system shown in FIG. 3A.

FIG. 3C a right side view of an example implementation of a component of an integrated separator and receiver system shown in FIG. 3A.

FIG. 3D a front elevational view of an example implementation of a component of an integrated separator and receiver system shown in FIG. 3A.

FIG. 3E is a perspective view of an example implementation of a component of an integrated separator and receiver system shown in FIG. 3A

FIG. 3F a front elevational view of an example implementation of a component of an integrated separator and receiver system shown in FIG. 3E.

FIG. 3G is a top view of an example implementation of a component of an integrated separator and receiver system shown in FIG. 3E.

FIG. 4A is a perspective view of an example implementation of an integrated separator and receiver system.

FIG. 4B is a front elevational view of an example implementation of an integrated separator and receiver system shown in FIG. 4A.

FIG. 4C is a right side view of FIG. 4A.

FIG. 4D is another example implementation of an integrated separator and receiver system shown in FIG. 4A comprising a rear cover panel.

FIG. 4E is a left side view of FIG. 4A.

FIG. 4F is a front elevational view of FIG. 4A.

FIG. 4G is a top plan view of FIG. 4A.

FIG. 5 is a component diagram illustrating an exploded view of the example embodiment of the system where one or more portions of one or more systems, described herein, may be implemented from FIGS. 4A-4G.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

In a gas generator or separator system, the actual separator component plays an important role, along with a non-return valve, and external plumbing. In one implementation, an integrated dual column component, can comprise two containers, columns or tanks that are coupled together. Previously, these combined tanks, containers, or columns were used as one long separator component. In one implementation, a first column of the dual column separator component can be plumbed like a typical gas generator. For example, the source gas (e.g., air) can enter the first column and pass through a layer of desiccant (e.g., adsorbent) to dry the source gas; then the dried source gas can pass through the separator material (e.g., adsorbent, such as CMS) to separate the unwanted gas (e.g., oxygen) from the target gas (e.g., nitrogen). In this example, the purified target gas (e.g., nitrogen) can pass through external plumbing, and through a non-return valve, and into the second column to store the purified gas and maintain high pressure, high purity target gas (e.g., nitrogen) for use.

In this implementation the second column is used as a receiver, instead of as an additional separator with adsorbent media. By adding additional media separation material to the first column, the need for a separate receiver is mitigated, including the additional size, plumbing, and labor. The result is a compact gas generator that can be less expensive, based on labor costs (e.g., production time) and component costs (e.g., less components), and can perform at or above the levels of current generators.

In one implementation, dual column, integrated separator-receiver component can be pressure tested to 5 times working pressure of the resulting pressurized, purified gas; and can be configured to operate at max pressures of an example system utilizing the dual chamber design. In this implementation, two columns comprising the separator (e.g., adsorbent) material may not be needed to provide the desired purity of the target gas. In one implementation, the separator column can be elongated to accommodate more separator material, to improve the separation process, and resulting purity of the target gas for the desired use.

In one aspect, the integrated, dual column separator-receiver component design can be utilized in a small, compact nitrogen generator. In this aspect, using less components can help to fit all of the system components into the small generator design, while reducing cost. Further, reducing the number of components (e.g., removing the need for a separate receiver), a slightly larger separator can be used in the first column for the gas separation functionality, and in the other column as the receiver. In this way, for example, the purity of the target gas can be improved, and the amount of stored, pressurized gas can be increased for applications that may have an increased demand for the target gas.

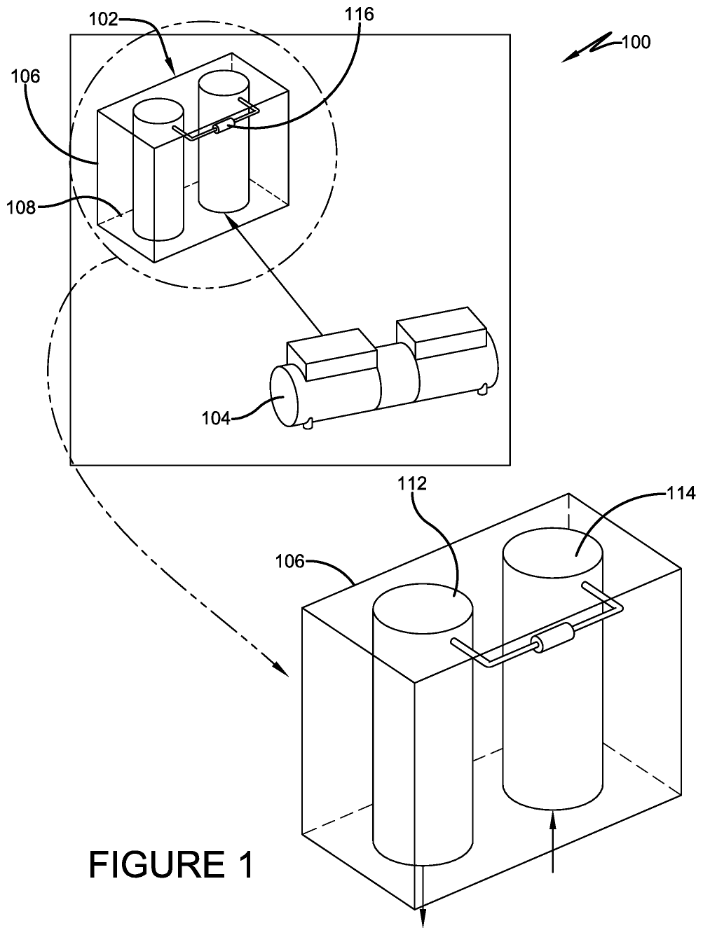

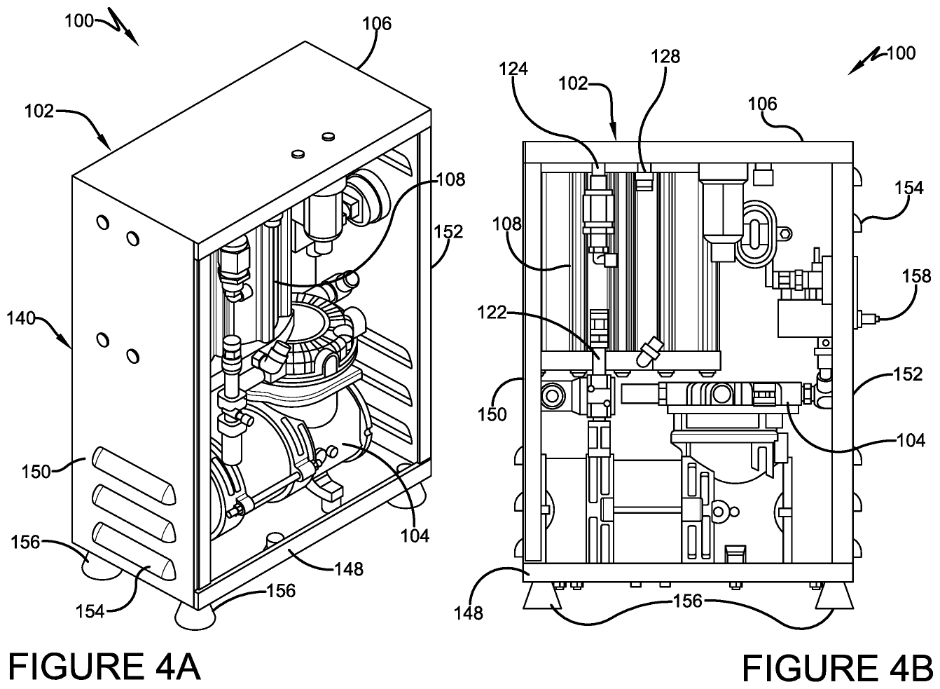

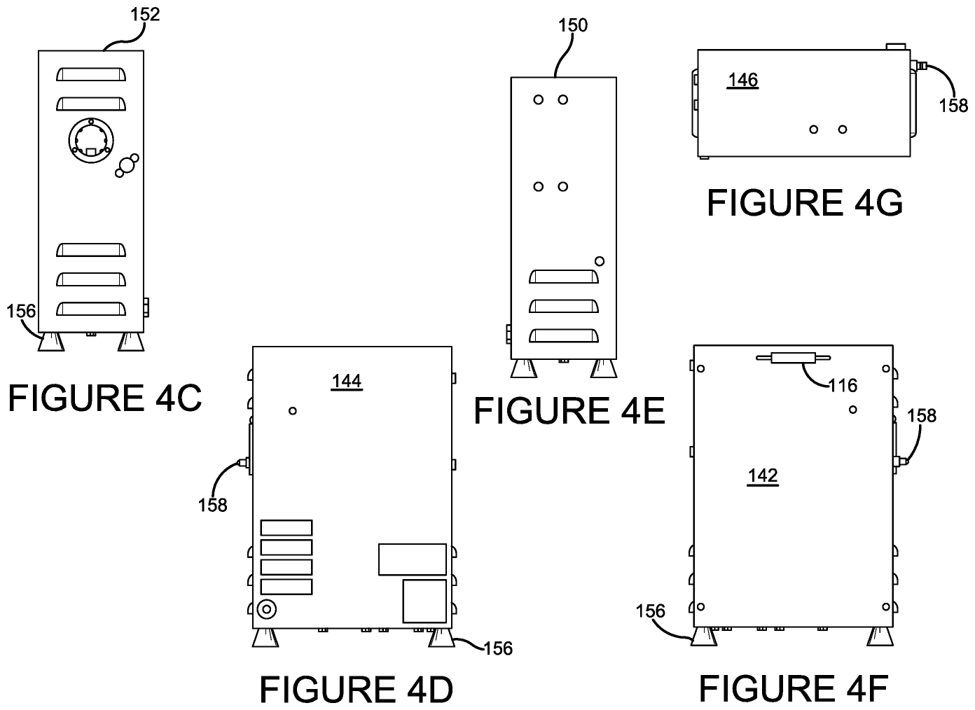

FIGS. 1-5 illustrate various views and implementations of a system for generating a target gas from a source gas 100. The system 100 may comprise a nitrogen generator 102 and a compressor 104. The nitrogen generator 102 may be portable and may comprise a housing 106 to surround or partially surround various nitrogen generator components. The compressor 104 may be sized and configured in a manner chosen with sound engineering judgment. The compressor 104 may be an external component of the system 100 as shown in FIG. 1. In yet another implementation, the compressor 104 may be disposed within the nitrogen generator housing 106 as shown in FIGS. 4A and 4B.

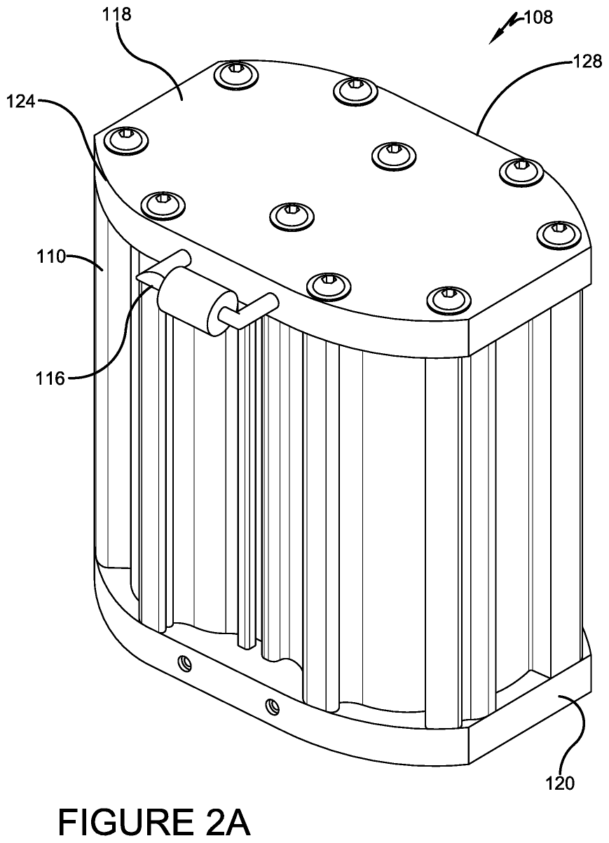

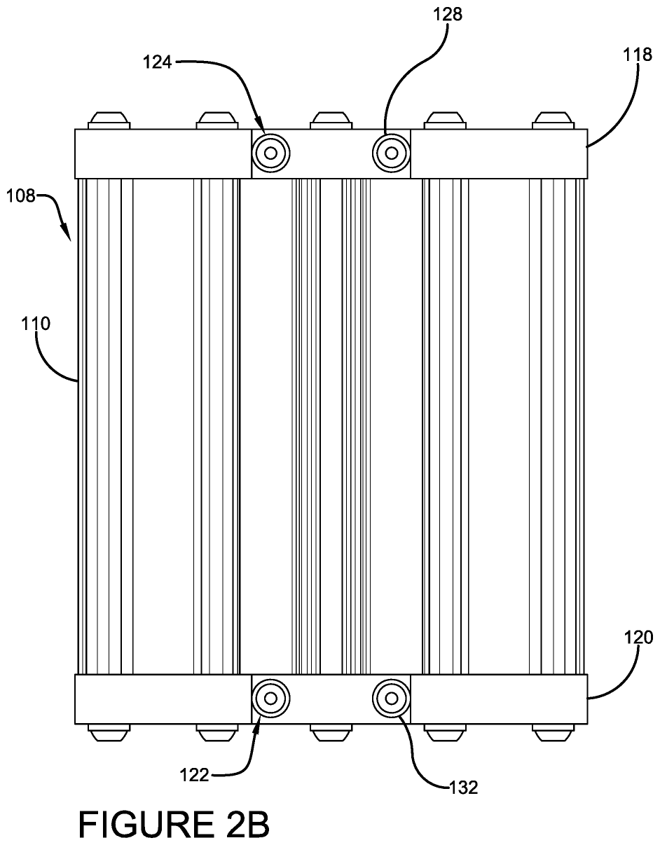

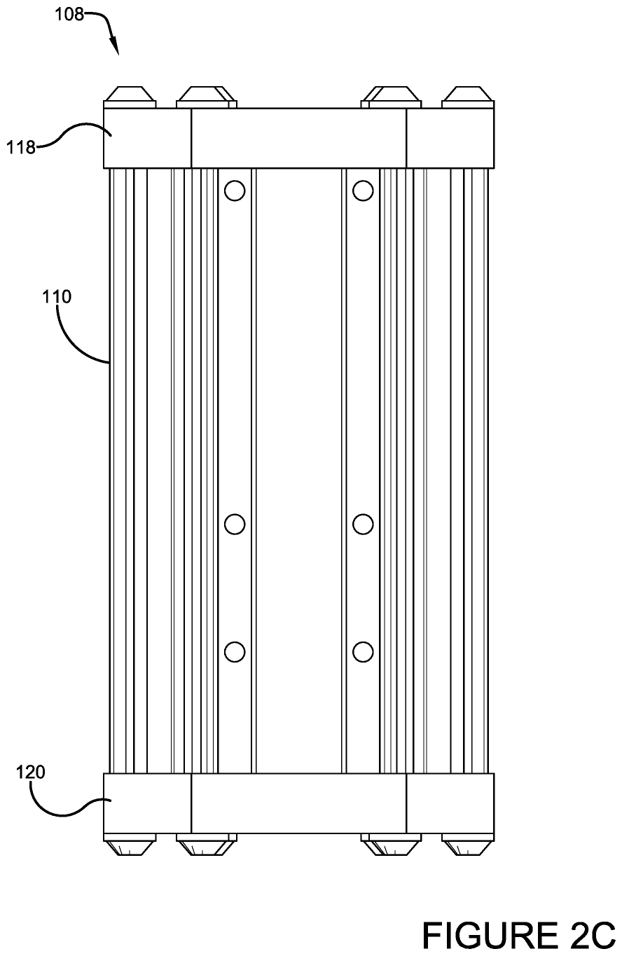

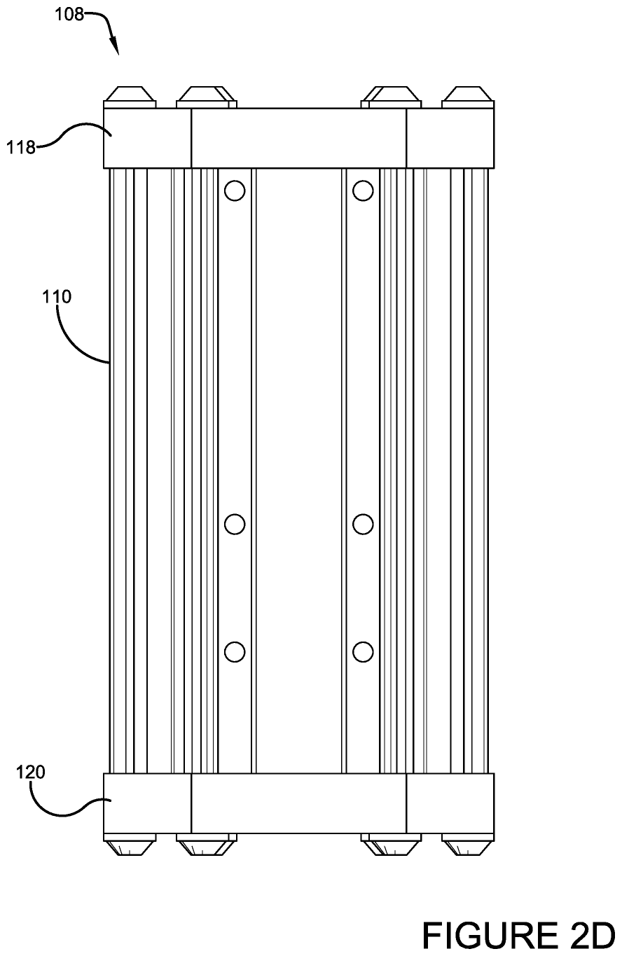

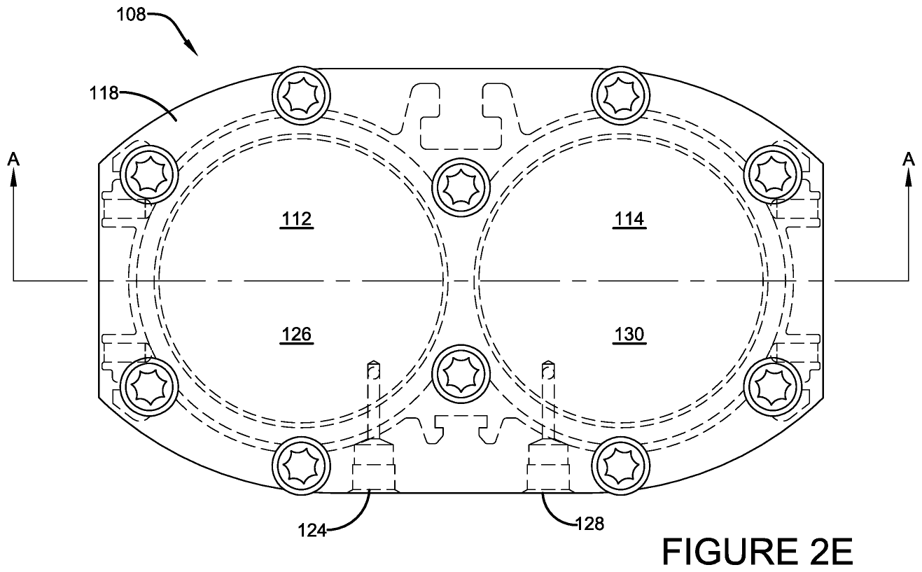

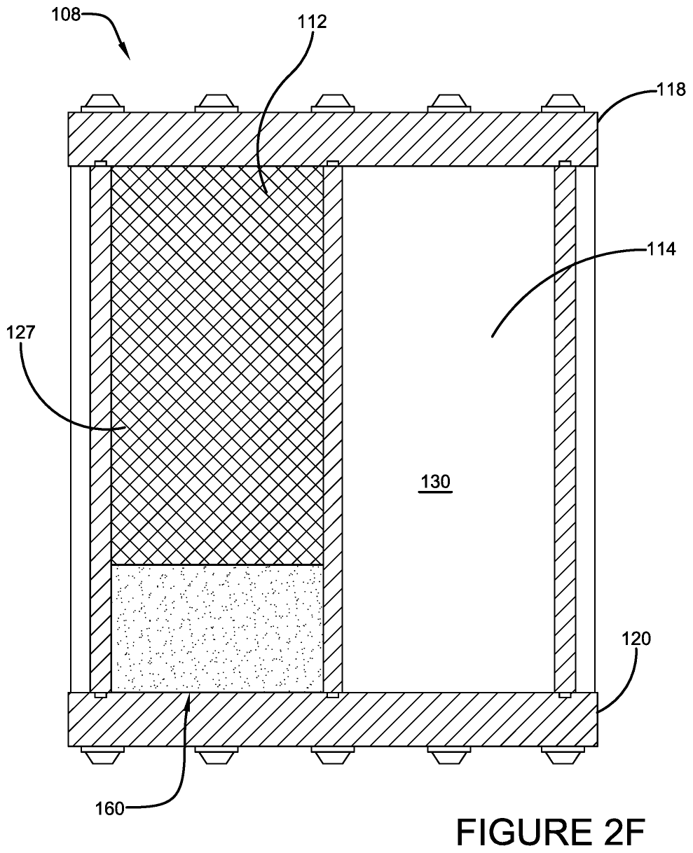

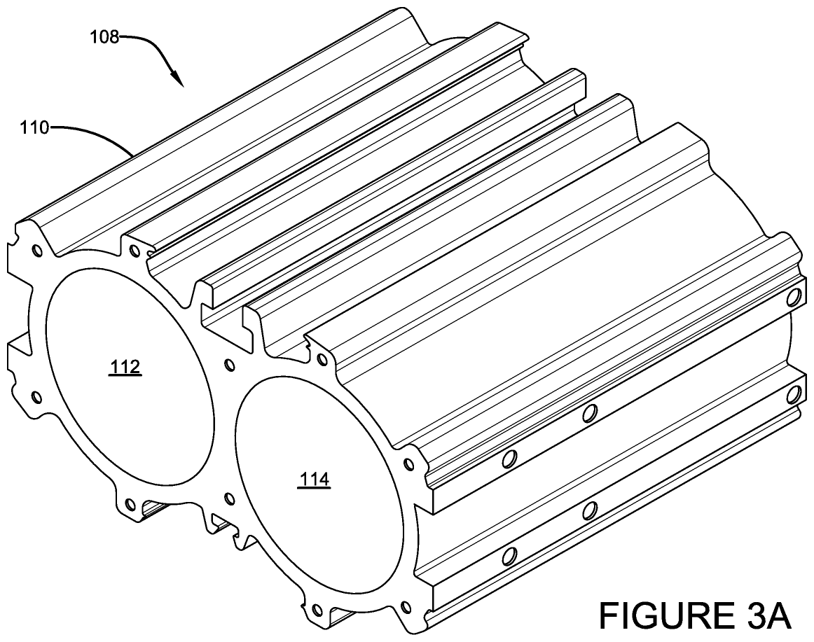

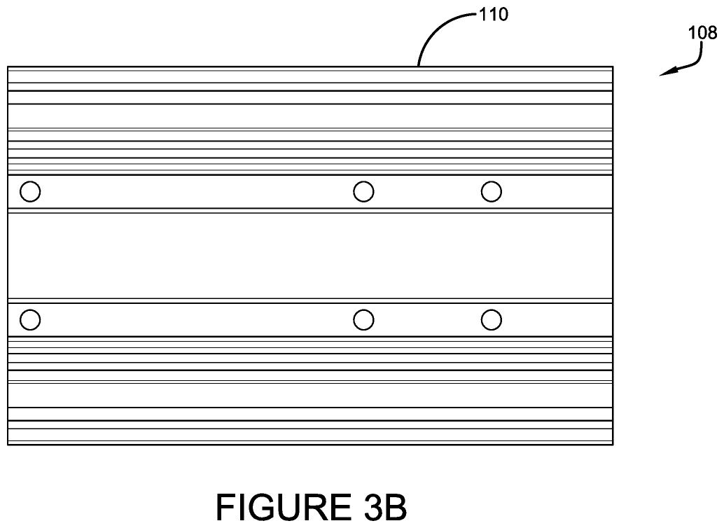

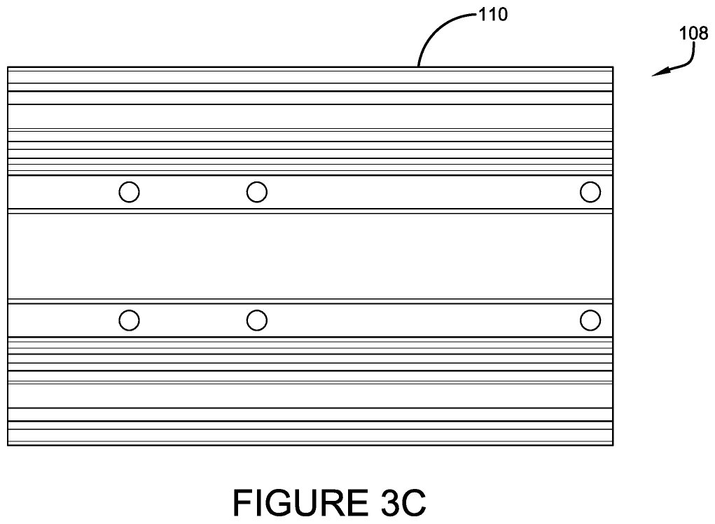

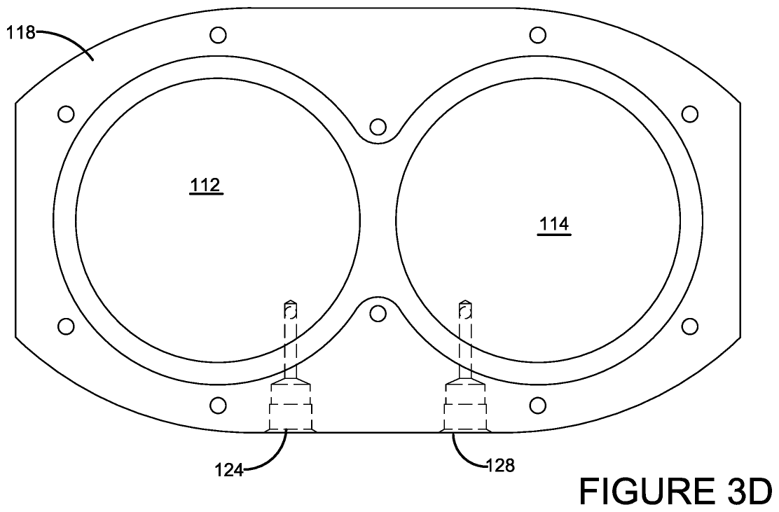

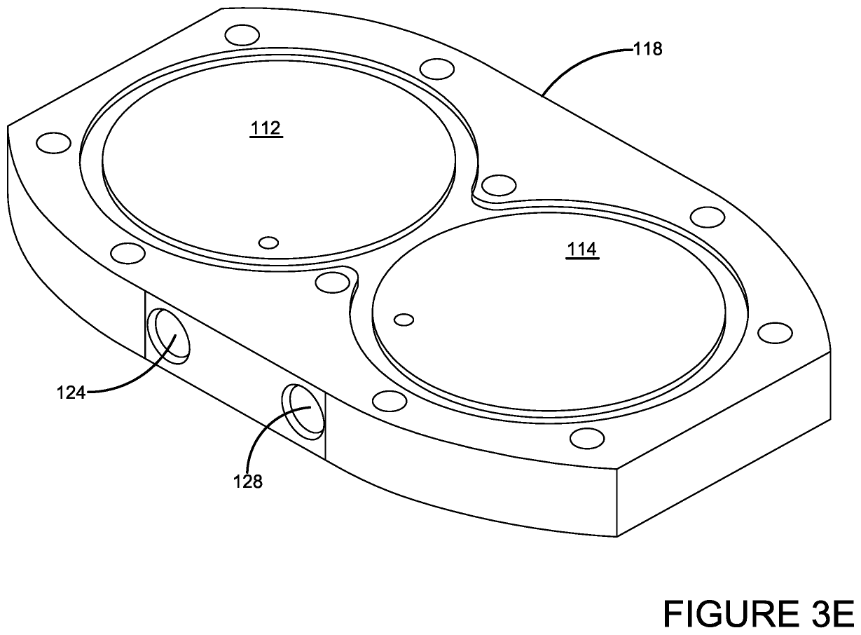

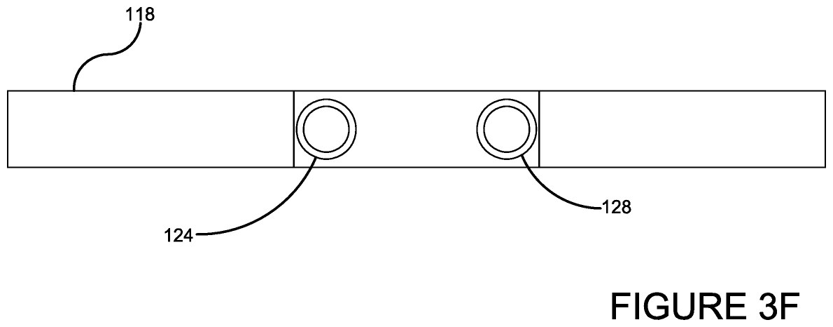

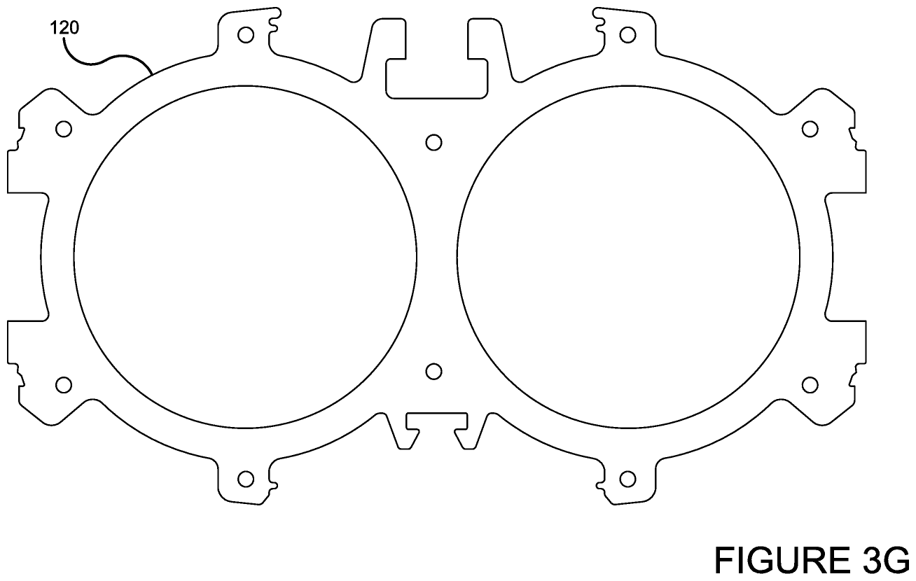

With reference to FIGS. 2A-2F and 3A-3G, a gas separator component 108 may comprise a frame 110. The frame may comprise a first column 112 and a second column 114. The first column 112may be fluidly coupled with the second column 114. A one-directional valve 116 may fluidly couple the first column 112 with the second column 114. The one-directional valve may be a non-return valve, a check-valve, a one-way valve or the like. The one-directional valve 116 may be configured to ensure separated target gas entering the second column 114 does not flow backwards into the first column 112.

A top end plate 118 and a bottom end plate 120 may be oppositely disposed from each other and may be operably connected to the frame 110. In one implementation, the top end plate 118 and the bottom end plate 120 may be bolted to the frame; however, any method chosen with sound engineering judgment may be utilized. The frame 110, the top end plate 118, and the bottom end plate 120 may form a casing for the first column 112 and the second column 114. A source gas inlet port 122 may be disposed at one end of the first column 112. In one implementation, the source gas inlet port 122 may be disposed in the bottom end plate 120 and extend through and into the first column 112. A target gas outlet 124 may be disposed at an opposite end of the first column. In one example implementation, the target gas outlet port may be disposed in the top end plate 118. The target gas outlet 124 may extend from inside the first column 112 and through the top end plate 118.

With further reference to FIGS. 2A-2F and 3A-3G, the first column 112 may comprise an internal chamber 126. The internal chamber 126 may comprise media separation material 127. Media separation material may be one or more materials utilized to separate a source gas, for example, air, into a target gas, such as purified nitrogen. Examples of media separation material 127 may include without limitation, filters, oxygen-absorbing molecular sieves, known as CMS (carbon molecular sieve) to remove the oxygen from the compressed air stream, adsorbent materials, desiccant layers, and the like. In one nonlimiting implementation, as shown in FIG. 2F, the first column 112 may comprise a first filter 160, a desiccant portion 162, a second filter 164, a CMS portion 166 and a third filter 168. In one example, in order for the first column 112 to accomplish separation of oxygen and other components to result in purified nitrogen or other target gas, without the need of a second separation chamber, the height of the first column 112 may be increased to provide for sufficient media separation material 127. By way of nonlimiting example, a prior system may comprise two separation columns each able to hold 0.2 liters of media separation material. However, in one implementation as shown in the FIGURES, the first column 112 may accommodate 0.4 liter of media separation material 127 all disposed in the internal chamber 126 of the first column 112.

After the source gas goes through the media separation material 127, the resulting gas is target gas, such as nitrogen. Nitrogen passes through the target gas outlet 124 and through the one-directional valve 116 and into the target gas inlet port 128 to enter the second column 114.

The second column 114 may be operably connected to the frame 110. Further, the second column 114 may be fluidly coupled with the first column 112. The second column 114 may comprise a storage chamber 130. The storage chamber 130 may be an internal storage chamber. The storage chamber 130 may be free of any media separation material. As such, the second column 114 may not provide for any further separation of the source gas. In one example implementation, the storage chamber 130 extends the full dimension of the second column 114. In another implementation, the storage chamber 130 may be a portion or the second column 114. In another implementation, the second column 114 may be configured to receive and store the target gas in the storage chamber 130 in a pressurized disposition. For example, the pressurized disposition of the second column may comprise about 125 psi. In another nonlimiting example, the pressurized disposition of the second column 114 may be about 100 psi. The pressurized disposition of the target gas in the second column 114 may be adjusted according to sound engineering judgment based upon a particular application. In another implementation, the second column 114 may comprise a pressurized target gas outlet 132 to provide the target gas for use in a target operation. In one nonlimiting implementation, the target gas may be nitrogen used in a target operation of brewing coffee.

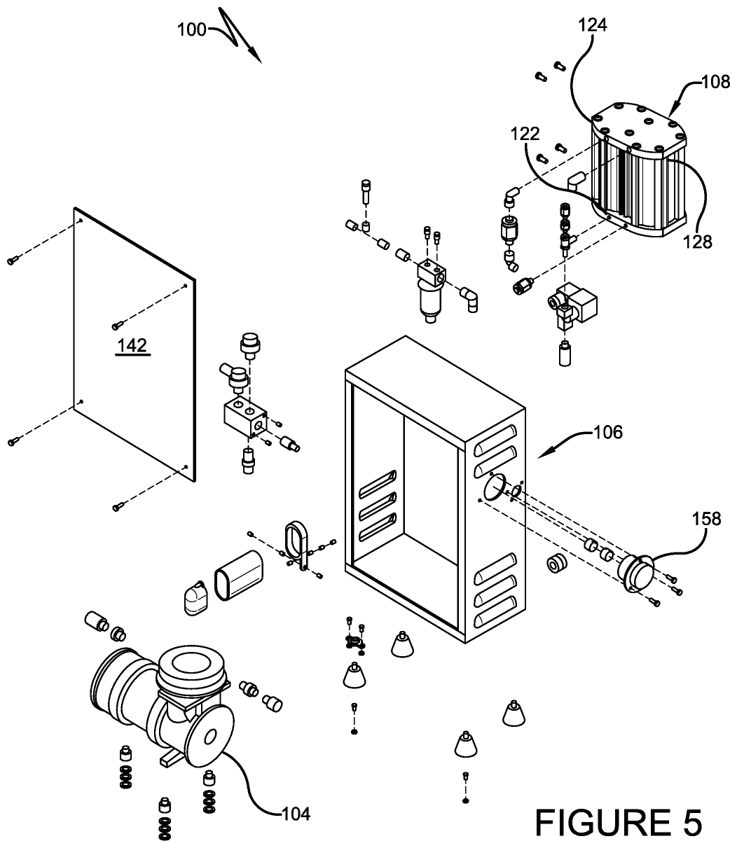

With reference to FIGS. 4A-4G and FIG. 5, another implementation of another system for generating a target gas from a source gas 100 is shown. The system 100 may take the form of a nitrogen generator. The housing 106 may comprise a plurality of panels 140 forming a unit. As shown in FIGS. 4A-4G and FIG. 5, the housing 106 may have a front panel 142, a rear panel 144, a top panel 146, a bottom panel 148, a left panel 150 and a right panel 152. The left panel 150 and the right panel 152 may have vents 154 defined therein for dissipating heat and promoting air circulation. The vents 154 may be disposed on any of the other panels. The bottom panel 148 may have feet operably connected thereto to support the housing 106 and promote air circulation under the housing 106. The inside of the housing may l06 have the other system components disposed therein as previously described. The compressor 104 may be disposed on the bottom panel 148. The gas separator and receiver component 108 may be positioned above the compressor 104. The pressurized target gas outlet 132 may be fluidly coupled with the second column 114. In one nonlimiting implementation, the right panel 152 may have a dispensing component 158 fluidly coupled with the pressurized target gas outlet 132 so that a user may selectably dispense pressurized target gas, such as nitrogen, for a desired application.

A method for generating and storing compressed nitrogen with an integrated, dual column separator-receiver will now be described. Air, or other source gas, may be supplied by a compressor 104 through a source gas inlet 122 at a first end of a first column 112. Air may pass through the media separation material 127 disposed inside the first column 112. Water vapor may be separated from the source gas with a desiccant material layer, resulting in a dry source gas. Nitrogen may then be separated from other components of the dry source gas with an adsorbent material layer, resulting in a purified form of nitrogen gas. Any combination of media separation material may be used to result in a purified form of nitrogen gas. The purified nitrogen gas may then pass from the first column 112 to the second column 114 through the one-directional valve 116. The one-directional valve 116 may be at least partially disposed outside the housing 106. In another implementation, the one-directional valve 116 may be completely outside the housing 106 to save space in the nitrogen generator. In yet another implementation, the one-directional valve may be integrated into one of the end plates, such as the top end plate 118.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. An integrated gas separator and receiver, comprising:
a frame;
a first column operably connected to the frame, comprising:
a source gas inlet;
a target gas outlet;
a first column chamber; and
a media separation material disposed inside the first column chamber;
a second column operably connected to the frame and fluidly coupled with the first column, the second column comprising a storage chamber.

2. The integrated gas separator and receiver of claim 1, further comprising:
a one-directional valve fluidly coupling the first column with the second column.

3. The integrated gas separator and receiver of claim 2, wherein the one-directional valve is disposed outside a housing, the housing comprising at least a portion of the first column and at least a portion of the second column.

4. The integrated gas separator and receiver of claim 1, wherein the media separation material comprises:
a desiccant material layer; and
an adsorbent material layer.

5. The integrated gas separator and receiver of claim 4, wherein the desiccant material layer is configured to separate water vapor from a source gas, resulting in a dry source gas; and the adsorbent material layer is configured to separate a target gas from other components of the dry source gas, resulting in a purified form of a target gas.

6. The integrated gas separator and receiver of claim 1, the second column configured to receive and store a target gas in the storage chamber in a pressurized disposition, the second column comprising a pressurized target gas outlet to provide the target gas for use in a target operation.

7. The integrated gas separator and receiver of claim 1, wherein the second column storage chamber is free of media separation material.

8. The integrated gas separator and receiver of claim 1, wherein a target gas to be stored in the storage chamber of the second column is nitrogen.

9. A system for generating a target gas from a source gas, comprising:
an integrated, dual column separator-receiver component, comprising:
a first column comprising:
a source gas inlet disposed at a first end;
a target gas outlet disposed at a second end, oppositely disposed from the first end; and
a media separation material disposed inside the first column;
a second column integrated with the first column, and in fluid communication with the target gas outlet, and comprising a storage chamber for receiving and storing the target gas in a pressurized disposition, the second column comprising a pressurized target gas outlet to provide the target gas for use in a target operation; and
a source gas compressor fluidly coupled with the source gas inlet to collect and compress the source gas, and provide the compressed source gas to the source gas inlet.

10. The system of claim 9, for generating a target gas from a source gas, wherein the media separation material further comprises a desiccant material layer configured to separate water vapor from the source gas, resulting in a dry source gas; and
an adsorbent material layer configured to separate the target gas from other components of the dry source gas, resulting in a purified form of the target gas.

11. The system of claim 9, wherein the target gas is nitrogen.

12. The system of claim 9, wherein the source gas is air.

13. The system of claim 9, further comprising a one-directional valve fluidly coupling the first column with the second column.

14. The system of claim 13, the integrated, dual column separator-receiving component comprising a housing, the one-directional valve fluidly coupling the first column and the second column at least partially external to the housing.

15. The system of claim 9, the pressurized target gas being nitrogen, and the second column being pressurized to about 125 psi.

16. The system of claim 9, the second column being free of separator media material.

17. A method for generating and storing compressed nitrogen with an integrated, dual column separator-receiver, comprising the steps of:
supplying air through a source gas inlet at a first end of a first column;
passing the air through a media separation material disposed inside the first column;
forming a purified nitrogen gas; and
passing the purified nitrogen gas out of a target gas outlet of the first column and into a storage chamber of a second column.

18. The method of claim 17, wherein the first column is at least partially disposed in a housing and the second column is at least partially disposed in the housing; the purified nitrogen gas passes from the first column to the second column through a one-directional valve, the one-directional valve being at least partially outside the housing or operably connected to an end plate of the integrated, dual column separator-receiver.

19. The method of claim 18, wherein the second chamber is free of media separation material.

20. The method of claim 17, wherein the step of passing the air through a media separation material disposed inside the first column further comprises:
separating water vapor from the source gas with a desiccant material layer, resulting in a dry source gas; and
separating the nitrogen from other components of the dry source gas with an adsorbent material layer, resulting in a purified form of nitrogen gas.
